(19) United States
(12) Patent Application Publication
(10) Pub. No.: US 2022/0134946 A1
(43) Pub. Date: May 5, 2022

(54) DEPLOYABLE WARNING DEVICE FOR VEHICLE

(71) Applicant: Oshkosh Corporation, Oshkosh, WI (US)

(72) Inventor: Gregory S. Brulo, Oshkosh, WI (US)

(73) Assignee: Oshkosh Corporation, Oshkosh, WI (US)

(21) Appl. No.: 17/513,428

(22) Filed: Oct. 28, 2021

Related U.S. Application Data
(60) Provisional application No. 63/107,122, filed on Oct. 29, 2020.

(51) Int. Cl. B60Q 1/50; B60Q 1/26

(52) U.S. Cl. CPC B60Q 1/50; B60Q 1/2692

(57) ABSTRACT

A vehicle defines a vehicle footprint. The vehicle includes a chassis, a cab coupled to the chassis that accommodates an operator, and a warning system coupled to a portion of the vehicle. The warning system includes a warning device and a deployment mechanism coupled to the warning device. The warning device includes at least one of a light assembly having a plurality of lights, a flag, or a sign. The deployment mechanism is configured to facilitate repositioning the warning device between a stowed position and a deployed position. When in the stowed position, the warning device is completely positioned within or substantially positioned within the vehicle footprint. When in the deployed position, the warning device extends out of the vehicle footprint and is positioned at a height sufficient so as not to impede the operator as the operator moves around the vehicle footprint.

### CROSS-REFERENCE TO RELATED PATENT APPLICATION

This application claims the benefit of and priority to U.S. Provisional Patent Application No. 63/107,122, filed Oct. 29, 2020, which is incorporated herein by reference in its entirety.

### BACKGROUND

A vehicle that makes frequent stops, often parks along the side of a road, and/or is used in hazardous conditions (e.g., at night, during a snow storm, etc.) can create a driving hazard for other vehicles traveling past the stopped, parked, or slow-moving vehicle. Traditionally, to warn of such a vehicle, (i) static road signs or electronic message boards are positioned ahead of the vehicle with a warning message or an arrow instructing other drivers to move over and proceed with caution and/or (ii) fixed lighting devices on the vehicle (e.g., taillights, hazard lights, a rooftop light bar, etc.) flash and/or change colors to make the other drivers aware of the vehicle's presence.

### SUMMARY

One embodiment relates to a vehicle. The vehicle defines a vehicle footprint. The vehicle includes a chassis, a cab coupled to the chassis that accommodates an operator, and a warning system coupled to a portion of the vehicle. The warning system includes a warning device and a deployment mechanism coupled to the warning device. The warning device includes at least one of a light assembly having a plurality of lights, a flag, or a sign. The deployment mechanism is configured to facilitate repositioning the warning device between a stowed position and a deployed position. When in the stowed position, the warning device is completely positioned within or substantially positioned within the vehicle footprint. When in the deployed position, the warning device extends out of the vehicle footprint and is positioned at a height sufficient so as not to impede the operator as the operator moves around the vehicle footprint.

Another embodiment relates to a vehicle. The vehicle includes a chassis, a cab coupled to the chassis, a rear assembly coupled to the chassis, a first light bar, and a second light bar. The cab is configured to accommodate an operator. The rear assembly includes a headboard positioned behind the cab and a platform extending rearward of the headboard. The first light bar is coupled proximate a first lateral side of the headboard. The second light bar is coupled proximate an opposing second lateral side of the headboard. The first light bar and the second light bar are repositionable between a stowed position and a deployed position. When in the stowed position, the first light bar is (i) positioned in front of the headboard between the cab and the headboard, (ii) behind the headboard, or (iii) along the first lateral side of the headboard. When in the stowed position, the second light bar is (i) positioned in front of the headboard between the cab and the headboard, (ii) behind the headboard, or (iii) along the opposing second lateral side of the headboard. When in the deployed position, the first light bar and the second light bar extend outward from the headboard of the vehicle.

Still another embodiment relates to a vehicle. The vehicle includes a chassis, a cab coupled to the chassis, a first light bar coupled to a first portion of the vehicle, a second light bar coupled to a second portion of the vehicle, a first deployment mechanism, and a second deployment mechanism. The first deployment mechanism and the second deployment mechanism are configured to facilitate repositioning the first light bar and the second light bar, respectively, between a stowed position and a deployed position. Each of the first deployment mechanism and the second deployment mechanism includes at least one of a rotary joint, one or more actuators, one or more locking mechanisms, or a linkage assembly. When in the deployed position, the first light bar and the second light bar extend outward from the vehicle and at an increased height relative to when in the stowed position.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a side plan view of a vehicle having a warning system, according to an exemplary embodiment.

FIG. 2 is a rear perspective view of the vehicle of FIG. 1 with the warning system in a stowed configuration, according to an exemplary embodiment

FIGS. 3 and 4 are various rear perspective views of the vehicle of FIG. 1 with the warning system in a deployed configuration, according to an exemplary embodiment

FIG. 5 is a detailed view of the warning system of FIG. 1, according to an exemplary embodiment.

FIG. 6 is a detailed view of the warning system of FIG. 1, according to another exemplary embodiment.

FIG. 7 is a detailed view of the warning system of FIG. 1, according to still another exemplary embodiment.

FIG. 8 is a detailed view of the warning system of FIG. 1, according to yet another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle includes a warning system. The warning system includes a deployment mechanism coupled the vehicle and a warning assembly coupled to the deployment mechanism. The deployment mechanism is configured to facilitate selectively repositioning the warning assembly between a stowed position and a working or deployed position. When in the deployed position, the warning assembly enhances visibility of the vehicle to warn approaching cars of the whereabouts of the vehicle. The deployment mechanism may be configured to deploy the warning assembly outside of a footprint of the vehicle and sufficiently high enough off of the ground so as not to impede, obstruct, or otherwise hinder an operator as the operator moves around the footprint of the vehicle (e.g., to retrieve tools stored in compartments along the vehicle, as the operator moves from the cab to the rear of the vehicle, etc.).

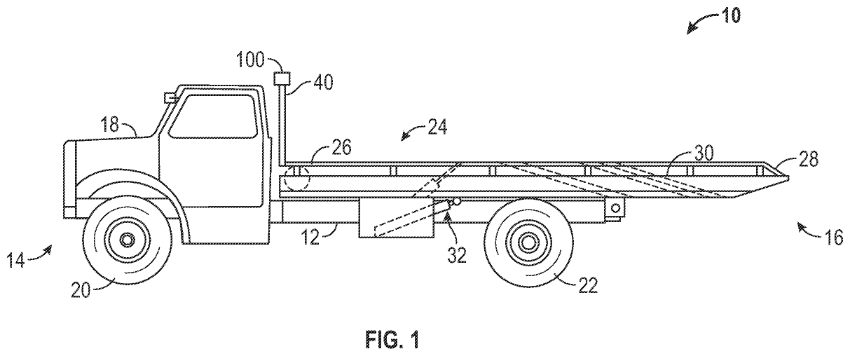

According to the exemplary embodiment shown in FIGS. 1-8, a vehicle, shown as vehicle 10, is a carrier truck or flatbed tow truck configured to facilitate transporting another vehicle or object. In other embodiments, the vehicle 10 is another type of tow truck such as an integrated tow truck, a hook and chain tow truck, a wheel-lift tow truck, etc. In still other embodiments, the vehicle 10 is another type of vehicle such as a response vehicle, a police vehicle, an ambulance, a Department of Transportation vehicle, a roadside assistance vehicle, a fire truck, a refuse truck, a plow truck, a construction vehicle, a street sweeper, a meter-maid vehicle, and/or still another type of vehicle (e.g., a vehicle that stops frequently, a vehicle that is often parked at the side of a road, a vehicle that is often used in severe weather conditions, etc.).

As shown in FIG. 1, the vehicle 10 includes a chassis, shown as frame 12. The frame 12 is a support structure for various components of vehicle 10. According to an exemplary embodiment, the frame 12 includes a pair of frame rails that are arranged in parallel. The pair of frame rails extend along a longitudinal direction (e.g., a fore and aft direction) between a front end 14 of the vehicle 10 and a rear end 16 of the vehicle 10. A longitudinal axis of the vehicle 10 extends parallel to the longitudinal direction between the pair of frame rails.

As shown in FIGS. 1, 2, and 4, the vehicle 10 include a cabin or passenger compartment, shown as cab 18, that is supported by the front end 14 of the frame 12. According to an exemplary embodiment, the cab 18 includes a seat and an enclosure to facilitate operation of the vehicle 10 by a driver. The cab 18 may also include components utilized by the driver during operation of vehicle 10 (e.g., hydraulic controls, switches, steering wheel, accelerator, brake, interfaces, etc.). The cab 18, in addition to the driver, may accommodate one or more passengers (e.g., one passenger, two passengers, three passengers, four passengers, five passengers, six passengers, etc.).

According to an exemplary embodiment, a plurality of wheels are rotatably coupled to axles that are coupled to the frame 12. As shown in FIG. 1, the vehicle 10 includes a first axle, shown as front axle 20, positioned proximate the front end 14 of the vehicle 10 and a second axle, shown as rear axle 22, positioned proximate the rear end 16 of the vehicle 10. In some embodiments, the vehicle 10 includes two or more rear axles 22. In various embodiments, the vehicle 10 has any number of wheel configurations including three, four, six, eight, or eighteen wheels, among other alternatives.

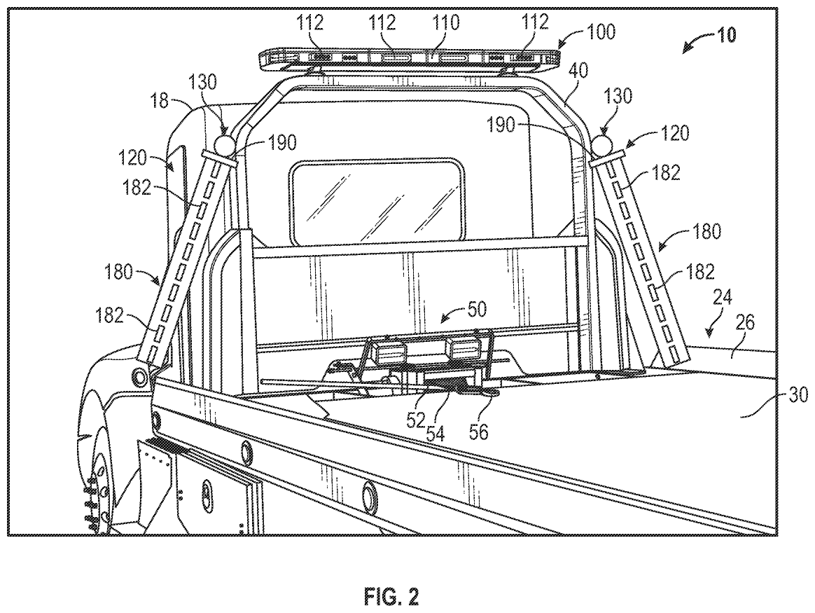

As shown in FIGS. 1-4, the vehicle 10 includes a rear assembly (e.g., a bed assembly, a rear compartment, a box container, a refuse compartment, a rear fire truck assembly, etc.), shown as rear assembly 24, positioned behind the cab 18. In some embodiments, the vehicle 10 does not include the rear assembly 24 (e.g., in embodiments where the vehicle 10 is a sedan, SUV, etc.). As shown in FIGS. 1 and 2, the rear assembly 24 has a first end, shown as fore end 26, and an opposing second end, shown as aft end 28. As shown in FIGS. 1-4, the rear assembly 24 includes (i) a support platform, shown as platform 30, that is configured to support a vehicle or other object and (ii) a front support, shown as headboard 40, coupled to and extending vertically upward from the fore end 26 of the platform 30. According to the exemplary embodiment shown in FIGS. 1-4, the platform 30 is movable relative to the frame 12 between a loading position and a transport position via an actuator assembly, shown as platform actuator assembly 32. In the loading position, the platform 30 forms an inclined ramp with the ground (e.g., to facilitate pulling a vehicle onto the platform 30, etc.). The platform actuator assembly 32 may include one or more actuators. The one or more actuators may be hydraulically-operated actuators, pneumatically-operated actuators, and/or electrically-operated actuators. In other embodiments, the platform 30 is fixed relative to the frame 12. In still other embodiments, the rear assembly 24 does not include the platform 30 and/or the headboard 40. By way of example, the rear assembly 24 may be otherwise designed or configured to suit another intended use of the vehicle 10 (e.g., a refuse compartment for a refuse truck, a truck bed for a truck, a box container for a box truck, a box container for an ambulance, a rear fire truck assembly for a fire truck, etc.).

As shown in FIG. 2, the vehicle 10 includes a winch assembly, shown as winch 50. The winch 50 may be used, for example, to pull an object onto the platform 30. In some embodiments, the winch 50 is used to pull a vehicle (e.g., an automobile, a tractor, a construction vehicle, a recreational vehicle, etc.) onto the platform 30. In other embodiments, the winch 50 is used to pull equipment (e.g., construction equipment, etc.) or another object onto the platform 30. As shown in FIG. 2, the winch 50 includes a line 54 (e.g., a wire, a rope, a cable, etc.) wound around a spool 52. The spool 52 is rotatably coupled to a drive mechanism (e.g., a hydraulic drive mechanism, an electric drive mechanism, etc.). A free end of the line 54 is coupled to an interfacing element, shown as hook 56. The hook 56 assists in the recovery of the vehicle or object. Tie downs (e.g., chains, cables, straps, etc.) may be used to secure the object to the platform 30 (e.g., during transit, etc.).

As shown in FIGS. 1-8, the vehicle 10 includes a warning system, shown as warning system 100. As shown in FIGS. 2-4, the warning system 100 includes a first light assembly or first warning device, shown as fixed light bar 110, coupled to a top portion or top bar of the headboard 40. In other embodiments, the fixed light bar 110 is otherwise positioned (e.g., on top of the cab 18, in embodiments that do not include the headboard 40, etc.). In some embodiments, the warning system 100 does not include the fixed light bar 110. As shown in FIG. 2, the fixed light bar 110 includes a plurality of lights (e.g., LEDs, light bulbs, etc.), shown as lights 112, that are selectively controllable to turn on and off, flash, and/or provide one or more dynamic flashing patterns. The lights 112 may be the same color (e.g., yellow, etc.) or various colors (e.g., white, blue, red, etc.). In some embodiments, the color of each of the lights 112 is selectively controllable (e.g., transitions between various colors; white, yellow, orange, green, blue, red, etc.)

As shown in FIGS. 2-8, the warning system 100 includes a plurality of second light assemblies or second warning devices, shown as deployable warning assemblies 120. According to the exemplary embodiment shown in FIGS. 2-8, the warning system 100 includes two of the deployable warning assemblies 120 where a first one of the deployable warning assemblies 120 is coupled to a top portion, a first corner, or a first side portion of the headboard 40 and a second one of the deployable warning assemblies 120 is coupled to the top portion, a second corner, or a second side portion of the headboard 40 opposite the first one of the deployable warning assemblies 120. In other embodiments, the deployable warning assemblies 120 are otherwise positioned and coupled to a different portion of the vehicle 10. By way of example, the deployable warning assemblies 120 may be coupled to opposing sides of a roof of the cab 18, coupled to opposing sides of a front bumper, coupled to opposing sides of a rear bumper, coupled to opposing sides of the fore end 26 of the rear assembly 24, and/or coupled to opposing sides of the aft end 28 of the rear assembly 24.

In some embodiments, the warning system 100 includes more than two of the deployable warning assemblies 120 or only one of the deployable warning assemblies 120 (e.g., positioned only on the driver's side or only positioned on the passenger's side of the vehicle 10). By way of example, a first set of the deployable warning assemblies 120 may be coupled to opposing sides of the front end 14 of the vehicle 10 (e.g., a front bumper, a front portion of the cab 18, to the cab 18, etc.) and a second set of deployable warning assemblies 120 may be coupled to opposing sides of the rear end 16 of the vehicle 10 (e.g., a rear bumper, a rear of the cab 18 if there is no rear assembly 24, a rear portion of the rear assembly 24, etc.). By way of another example, a first set of the deployable warning assemblies 120 may be coupled to opposing sides of the fore end 26 of the rear assembly 24 and a second set of deployable warning assemblies 120 may be coupled to opposing sides of the aft end 28 of the rear assembly 24. By way of still another example, a first set of the deployable warning assemblies 120 may be coupled to opposing sides of the front end 14 of the vehicle 10 and a second set of deployable warning assemblies 120 may be coupled to opposing sides of the fore end 26 of the rear assembly 24. By way of yet another example, a first set of the deployable warning assemblies 120 may be coupled to opposing sides of the front end of the vehicle 10, a second set of deployable warning assemblies 120 may be coupled to opposing sides of the fore end 26 of the rear assembly 24, and a third set of deployable warning assemblies 120 may be coupled to opposing sides of the aft end 28 of the rear assembly 24.

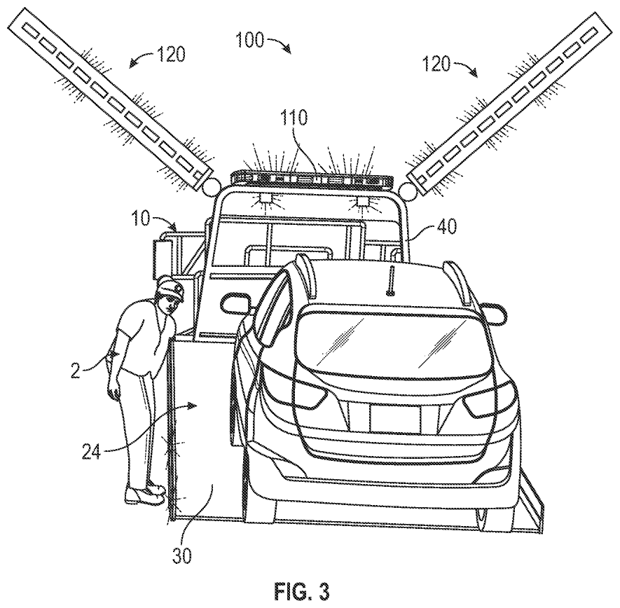

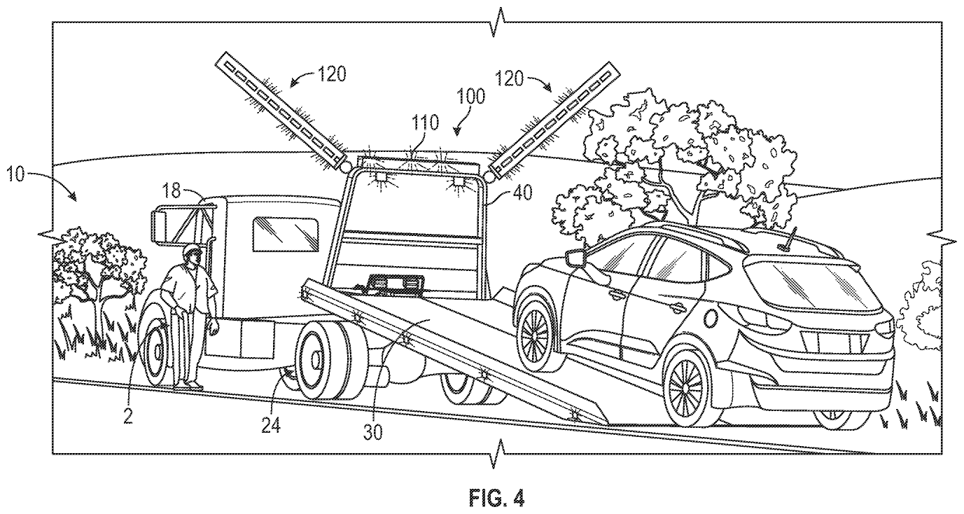

As shown in FIGS. 2 and 5-8, each of the deployable warning assemblies 120 includes (i) an actuation or repositioning mechanism, shown as deployment mechanism 130, coupled to the headboard 40, (ii) a light assembly, shown as light bar 180, coupled to the deployment mechanism 130, and (iii) a flexible or breakaway joint, shown as coupling joint 190, positioned between the deployment mechanism 130 and the light bar 180. According to an exemplary embodiment, the coupling joint 190 is configured flex or permit decoupling of the light bar 180 from the deployment mechanism 130 (e.g., a breakaway action, etc.) in the event of the light bar 180 hitting or being hit by something so as to limit or prevent damage to the deployment mechanism 130 and/or the light bar 180. While shown as being coupled to the headboard 40, it should be understood that the deployment mechanism 130 can be coupled to any suitable portion of the vehicle 10 (e.g., the front bumper, one or more portions of the cab 18, the rear bumper, one or more portions of the rear assembly 24 other than the headboard 40, etc.). According to an exemplary embodiment, the deployment mechanism 130 is configured to (i) pivotally couple the light bar 180 to a desired portion of the vehicle 10 and (ii) facilitate repositioning the light bar 180 between a stowed position, as shown in FIG. 2, and a deployed position, as shown in FIGS. 3 and 4.

According to an exemplary embodiment shown in FIGS. 2 and 5-8, the light bar 180 is completely positioned within or substantially positioned within a footprint of the vehicle 10 (i.e., the outer periphery of vehicle 10 if the warning system 100 were not present) when in the stowed positioned (e.g., when the vehicle 10 is being driven, when the vehicle 10 is not in use, etc.) such that the majority of, if not all of, the light bar 180 is positioned within the footprint and does not extend laterally outward therefrom. According to the exemplary embodiment shown in FIGS. 3-8, the light bar 180 extends outward and/or at an angle from the footprint of the vehicle 10 when in the deployed position (e.g., to the side of the vehicle 10, etc.). In some embodiments, the light bar 180 is positioned at a height above the ground and/or oriented at an angle sufficient so as not to impede, obstruct, or otherwise hinder (i) an operator 2 as the operator 2 moves around the footprint or exterior of the vehicle 10 (e.g., to retrieve tools stored in compartments along the vehicle 10, as the operator 2 moves from the cab 18 to the rear end 16 of the vehicle 10, etc.) and/or (ii) other vehicles that may be passing by the vehicle 10.

As shown in FIG. 2, each of the light bars 180 includes a plurality of lights (e.g., LEDs, light bulbs, etc.), shown as lights 182, that are selectively controllable to turn on and off, flash, and/or provide one or more dynamic flashing patterns. The lights 182 may be controlled to provide textual indications (e.g., “Proceed with Caution,” “Move Over,” “Work Area,” “Slow,” “Road Work Ahead,” etc.) and/or visual indications (e.g., an arrow indicating to move over, etc.). The lights 182 may be the same color (e.g., yellow, etc.) or various colors (e.g., white, blue, red, etc.). In some embodiments, the color of each of the lights 182 is selectively controllable (e.g., transitions between various colors; white, yellow, orange, green, blue, red, etc.). Accordingly, when in the deployed position, the light bars 180 can be activated to (i) enhance the visibility of the vehicle 10, (ii) warn approaching vehicles of the whereabouts of the vehicle 10 so that the drivers may take caution, and (iii) increase the awareness of passing traffic to the work zone of the operator 2.

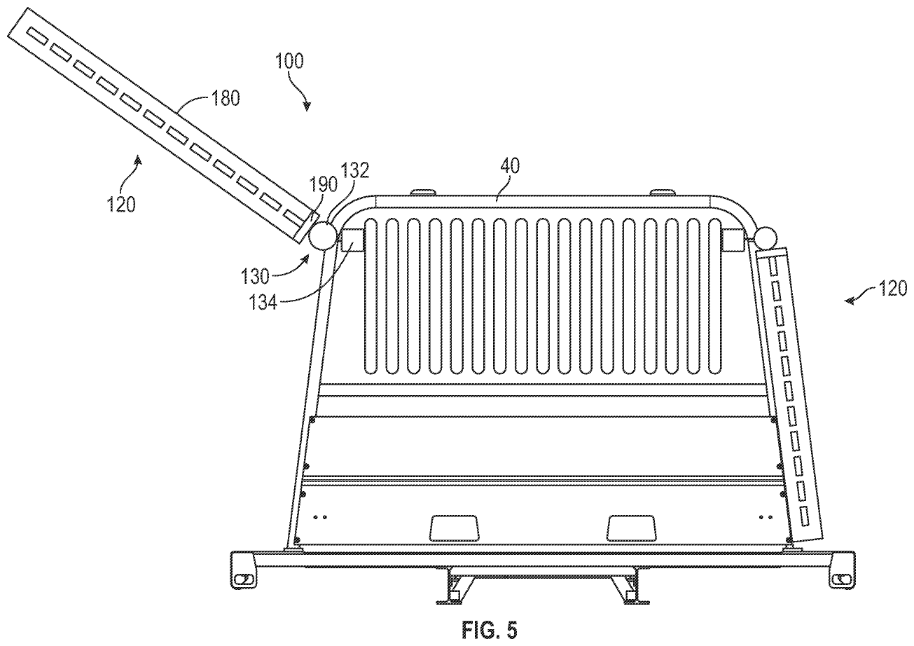

As shown in FIG. 5, the deployment mechanism 130 includes a pivotal coupler, shown as rotary joint 132. The rotary joint 132 facilitates selectively pivoting the light bar 180 between the stowed position (as shown by the deployable warning assembly 120 on the right side) and the deployed position (as shown by the deployable warning assembly 120 on the left side). While the rotary joint 132 is shown as being coupled to a side portion of the headboard 40, the rotary joint 132 may be coupled to any desirable portion of the vehicle 10 as described above. As shown in FIG. 5, the deployment mechanism 130 includes a driver (e.g., a rotary actuator, an electric motor, a hydraulically-operated motor, a pneumatically-operated motor, etc.), shown as actuator 134, that is coupled to the rotary joint 132 and that facilitates driving the rotary joint 132 to thereby pivot the light bar 180 between the stowed position and the deployed position. In other embodiments, the actuator 134 is a linear actuator that extends between the light bar 180 and a portion of the vehicle 10 (e.g., the headboard 40, the frame 12, etc.), and facilitates pivoting the light bar 180 about the rotary joint 132 between the stowed position and the deployed position. In some embodiments, the deployment mechanism 130 does not include the actuator 134 and, instead, the rotary joint 132 is manually rotatable and locked in place by the operator 2.

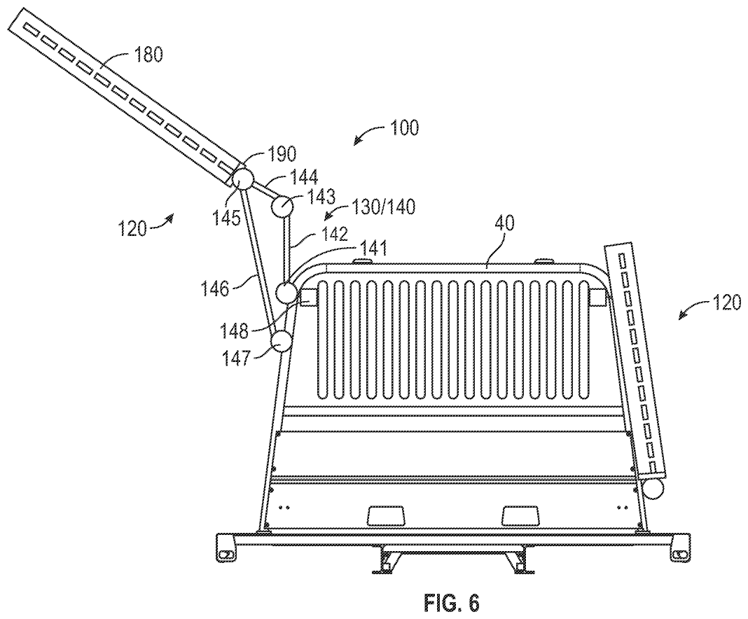

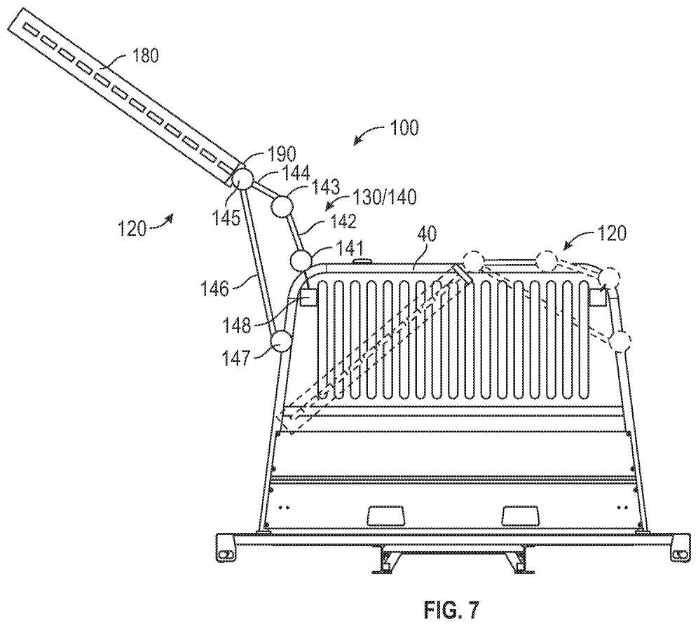

As shown in FIGS. 6 and 7, the deployment mechanism 130 includes a linkage assembly, shown as four-bar linkage 140. The four-bar linkage 140 facilitates selectively repositioning the light bar 180 between the stowed position (as shown by the deployable warning assembly 120 on the right side) and the deployed position (as shown by the deployable warning assembly 120 on the left side), as well as increasing the height of the light bar 180 (e.g., relative to using just the rotary joint 132). The four-bar linkage 140 includes a first linkage, shown as link 142, a second linkage, shown as link 144, a third linkage, shown as link 146, a first joint, shown as joint 141, a second joint, shown as joint 143, a third joint, shown as joint 145, and a fourth joint, shown as joint 147. The link 142 is pivotally coupled to the headboard 40 at a first point by the joint 141 (e.g., that is similar to the rotary joint 132, etc.) and the link 144 by the joint 143. The link 144 is pivotally coupled to the link 142 by the joint 143 and the link 146 by the joint 145, and coupled to the light bar 180 and the coupling joint 190 by the joint 145. The link 146 is pivotally coupled to the link 144 by the joint 145 and the headboard 40 at a second point by the joint 147 (e.g., that is similar to the rotary joint 132, etc.), and coupled to the light bar 180 and the coupling joint 190 by the joint 145. The joint 141 is spaced from the joint 147 along the headboard 40. The spacing between the first point and the second point along the headboard 40 defines the fourth link of the four-bar linkage 140.

As shown in FIG. 6, the joint 141 and the joint 147 are positioned along the headboard 40 such that the light bar 180 and the four-bar linkage 140 are disposed along the side of the headboard 40 when in the stowed position. As shown in FIG. 7, the joint 141 and the joint 147 are positioned along the headboard 40 such that (i) the light bar 180 is disposed in front of or behind the headboard 40 when in the stowed position and (ii) at least a portion of the four-bar linkage 140 extends along the top portion of the headboard 40 when in the stowed position. While the link 142 and the link 146 are shown as being coupled to a side portion of the headboard 40, the link 142 and the link 146 may be coupled to any desirable portion of the vehicle 10 as described above.

As shown in FIGS. 6 and 7, the deployment mechanism 130 includes a driver (e.g., a rotary actuator, an electric motor, a hydraulically-operated motor, a pneumatically-operated motor, etc.), shown as actuator 148, that is coupled to the joint 141 and that facilitates driving the joint 141 and thereby the whole four-bar linkage 140 to pivot the light bar 180 between the stowed position and the deployed position. In other embodiments, the actuator 148 is additionally or alternatively coupled to the joint 147. In other embodiments, the actuator 148 is a linear actuator that extends between one of the link 142, the link 144, or the link 146 and a portion of the vehicle 10 (e.g., the headboard 40, the frame 12, etc.), and facilitates driving the four-bar linkage 140 and repositioning the light bar 180 between the stowed position and the deployed position. In some embodiments, the deployment mechanism 130 does not include the actuator 148 and, instead, the four-bar linkage 140 is manually repositionable and locked in place by the operator 2.

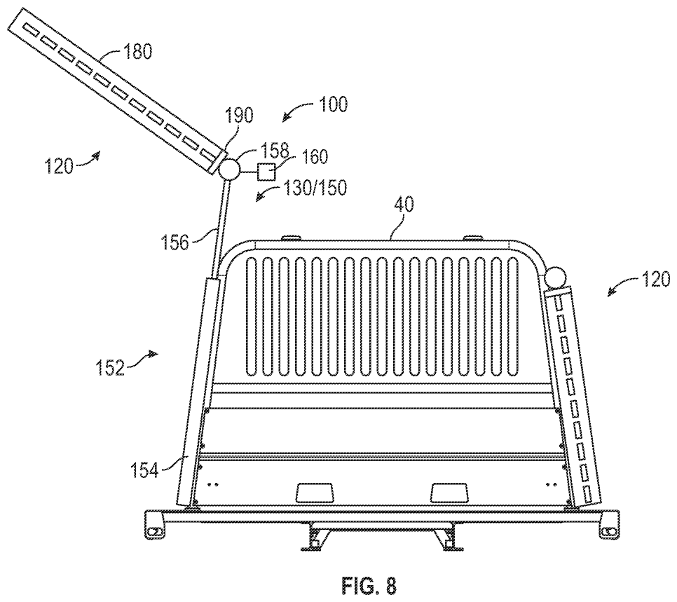

As shown in FIG. 8, the deployment mechanism 130 includes actuator system, shown as actuator assembly 150. The actuator assembly 150 facilitates selectively repositioning the light bar 180 between the stowed position (as shown by the deployable warning assembly 120 on the right side) and the deployed position (as shown by the deployable warning assembly 120 on the left side), as well as increasing the height of the light bar 180 (e.g., relative to using just the rotary joint 132). While the actuator assembly 150 is shown as being coupled to a side portion of the headboard 40, the actuator assembly 150 may be coupled to any desirable portion of the vehicle 10 as described above. The actuator assembly 150 includes a first actuator, shown as linear actuator 152; a joint, shown as rotary joint 158, coupled to the linear actuator 152 and the light bar 180; and a second actuator, shown as rotary actuator 160, coupled to the rotary joint 158. The linear actuator 152 includes a housing, shown as actuator housing 154, and an extendable arm, shown as arm 156, that extends from and retracts into the actuator housing 154.

In some embodiments, the linear actuator 152, the rotary joint 158, and/or the rotary actuator 160 are manually operated. By way of example, the operator 2 may manually rotate the light bar 180 about the rotary joint 158, lock the rotary joint 158 when the light bar 180 is at a desirable angle, and then lift the arm 156 to increase the height of the light bar 180 to a desirable height, which may then be locked in place. In some embodiments, the linear actuator 152 and/or the rotary actuator 160 are electrically-operated, hydraulically-operated, or pneumatically operated. By way of example, the linear actuator 152 may be an electric linear actuator, a hydraulic cylinder, and/or a pneumatic cylinder. By way of another example, the rotary actuator 160 may be an electric motor, a hydraulically-operated motor, and/or a pneumatically-operated motor.

In some embodiments, the deployment mechanism 130 used with the deployable warning assemblies 120 of FIGS. 4-8 includes a biased actuator (e.g., a linear spring, a torsional spring, a gas strut, a linearly-biased actuator, a rotationally-biased actuator, etc.), a locking mechanism (e.g., a latch, a pin, a strap, etc.), and/or a handle or tether coupled to the light bar 180. By way of example, the locking mechanism may be positioned to facilitate selectively securing the light bar 180 in the stowed position (e.g., to the headboard 40, to a portion of the vehicle 10, etc.). The biased actuator may be positioned to bias or reposition the light bar 180 from the stowed position to the deployed position when the locking mechanism is disengaged. The operator may pull on the handle, the tether, and/or the light bar 180 itself to stow or reposition the light bar 180 from the deployed position to the stowed position, and then secure the light bar 180 in the stowed position using the locking mechanism.

In some embodiments, in addition to or as an alternative to the light bars 180, the deployable warning assemblies 120 include an indicator (e.g., that does not include lights, etc.). The indicator may be or include a flag, a sign, a bright or fluorescent color, etc. The indicator may be used or positioned to increase visibility of the vehicle 10 during daytime operation. By way of example, the flag (e.g., a fluorescent flag, a bright flag, an orange flag, a yellow flag, a red flag, a green flag, etc.) may be coupled to a portion of the deployable warning assemblies 120 (e.g., a free end of the light bars 180, etc.). By way of another example, the sign may be coupled to a portion of the deployable warning assemblies 120 (e.g., a free end of the light bars 180, etc.) that provides textual indications (e.g., “Proceed with Caution,” “Move Over,” “Work Area,” “Slow,” “Road Work Ahead,” etc.) and/or visual indications (e.g., an arrow indicating to move over, a yield sign, a stop sign, a merge sign, etc.). The sign may also be bright or fluorescent colored. By way of still another example, the light bars 180 and/or other components of the deployable warning assemblies 120 may be painted or otherwise colored one of more fluorescent colors (e.g., yellow, green, etc.). In some embodiments, the flags, the signs, the light bars 180, and/or other components of the deployable warning assemblies 120 are reflective or glow-in-the-dark to increase visibility of the vehicle 10 during nighttime operation.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the warning system 100 and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A vehicle defining a vehicle footprint, the vehicle comprising:
a chassis;
a cab coupled to the chassis, the cab configured to accommodate an operator; and
a warning system coupled to a portion of the vehicle, the warning system including:
a warning device including at least one of a light assembly having a plurality of lights, a flag, or a sign; and
a deployment mechanism coupled to the warning device, the deployment mechanism configured to facilitate repositioning the warning device between a stowed position and a deployed position;
wherein, when in the stowed position, the warning device is completely positioned within or substantially positioned within the vehicle footprint; and
wherein, when in the deployed position, the warning device extends out of the vehicle footprint and is positioned at a height sufficient so as not to impede the operator as the operator moves around the vehicle footprint.

2. The vehicle of claim 1, further comprising a rear assembly coupled to the chassis and positioned behind the cab, wherein the warning system is coupled to the rear assembly.

3. The vehicle of claim 2, wherein the rear assembly includes a headboard positioned behind the cab and a platform extending rearward of the headboard, and wherein the warning device is coupled to the headboard.

4. The vehicle of claim 3, wherein, when in the stowed positioned, the warning device is positioned in front of the headboard between the cab and the headboard or behind the headboard.

5. The vehicle of claim 3, wherein, when in the stowed positioned, the warning device is positioned along a side of the headboard.

6. The vehicle of claim 1, wherein the portion of the vehicle includes at least one of a front bumper of the vehicle, a rear bumper of the vehicle, the cab of the vehicle, or a rear assembly of the vehicle.

7. The vehicle of claim 6, wherein the warning device is a first warning device, wherein the deployment mechanism is a first deployment mechanism, and wherein the warning system includes a second warning device and a second deployment mechanism.

8. The vehicle of claim 7, wherein the first warning device is coupled to a first side of the front bumper, the rear bumper, the cab, or the rear assembly, and wherein the second warning device is coupled to an opposing second side of the front bumper, the rear bumper, the cab, or the rear assembly.

9. The vehicle of claim 7, wherein the first warning device is coupled to one of the front bumper, the rear bumper, the cab, or the rear assembly, and wherein the second warning device is coupled to a different one of the front bumper, the rear bumper, the cab, or the rear assembly.

10. The vehicle of claim 1, wherein the warning system includes a flexible or breakaway joint coupling the warning device to the deployment mechanism.

11. The vehicle of claim 1, wherein the deployment mechanism includes at least one of a rotary joint, a linkage assembly, or an actuator positioned to at least one of (i) pivot the warning device about the rotary joint between the stowed position and the deployed position or (ii) increase a height of the warning device when repositioned from the stowed position to the deployed position.

12. The vehicle of claim 11, wherein the deployment mechanism includes the linkage assembly, the linkage assembly configured to pivot the warning device between the stowed position and the deployed position while increasing the height of the warning device when repositioned from the stowed position to the deployed position.

13. The vehicle of claim 11, wherein the deployment mechanism includes the rotary joint and the actuator.

14. The vehicle of claim 13, wherein the actuator is (i) a linear actuator extending between the portion of the vehicle and the warning device or (ii) a rotary actuator positioned at or coupled to the rotary joint.

15. The vehicle of claim 13, wherein the actuator is a biased actuator that biases the warning device into the deployed position, and wherein the deployment mechanism includes a locking mechanism configured to facilitate securing the warning device in the stowed position.

16. The vehicle of claim 13, wherein the actuator includes a pivot actuator and an extension actuator, and wherein each of the pivot actuator and the extension actuator is hydraulically-operated, electrically-operated, or pneumatically-operated.

17. The vehicle of claim 13, wherein the actuator includes a pivot actuator and an extension actuator, wherein at least one of the pivot actuator or the extension actuator is manually operated.

18. The vehicle of claim 11, wherein the deployment mechanism includes the rotary joint, wherein the warning device is manually pivotable about the rotary joint, and wherein the deployment mechanism includes a locking mechanism configured to facilitate manually securing the warning device in the deployed position.

19. A vehicle comprising:
a chassis;
a cab coupled to the chassis, the cab configured to accommodate an operator;
a rear assembly coupled to the chassis, the rear assembly including a headboard positioned behind the cab and a platform extending rearward of the headboard;
a first light bar coupled proximate a first lateral side of the headboard; and
a second light bar coupled proximate an opposing second lateral side of the headboard;
wherein the first light bar and the second light bar are repositionable between a stowed position and a deployed position;
wherein, when in the stowed position, the first light bar is (i) positioned in front of the headboard between the cab and the headboard, (ii) behind the headboard, or (iii) along the first lateral side of the headboard;
wherein, when in the stowed position, the second light bar is (i) positioned in front of the headboard between the cab and the headboard, (ii) behind the headboard, or (iii) along the opposing second lateral side of the headboard; and
wherein, when in the deployed position, the first light bar and the second light bar extend outward from the headboard of the vehicle.

20. A vehicle comprising:
a chassis;
a cab coupled to the chassis, the cab configured to accommodate an operator;
a first light bar coupled to a first portion of the vehicle;
a second light bar coupled to a second portion of the vehicle;
a first deployment mechanism; and
a second deployment mechanism;
wherein the first deployment mechanism and the second deployment mechanism are configured to facilitate repositioning the first light bar and the second light bar, respectively, between a stowed position and a deployed position;
wherein each of the first deployment mechanism and the second deployment mechanism includes at least one of a rotary joint, one or more actuators, one or more locking mechanisms, or a linkage assembly; and
wherein, when in the deployed position, the first light bar and the second light bar extend outward from the vehicle and at an increased height relative to when in the stowed position.
